(19) United States
(12) Patent Application Publication
(10) Pub. No.: US 2023/0092421 A1
(43) Pub. Date: Mar. 23, 2023

(54) VERTICAL FARMING WATERING SYSTEM AND METHODS OF MAKING AND USE THEREFOR

(71) Applicants: Freight Farms, Inc., Boston, MA (US); W.L. Gore and Associates, Inc., Newark, DE (US)

(72) Inventors: Jacob FELSER, Boston, MA (US); Jonathan FRIEDMAN, Boston, MA (US); Nigel SLATER, Boston, MA (US); Paul BIELEWICZ, Newark, DE (US); Edward H. CULLY, Newark, DE (US)

(21) Appl. No.: 17/933,309

(22) Filed: Sep. 19, 2022

Related U.S. Application Data
(60) Provisional application No. 63/247,615, filed on Sep. 23, 2021.

(51) Int. Cl. A01G 31/06

(52) U.S. Cl. CPC A01G 31/06

(57) ABSTRACT

A vertical farm system including a rack having a grow channel and a source of moisture/nutrients, the moisture/nutrients being deliverable to the rack. The system includes malleable material inserts in the grow channel. The malleable material inserts have an edge area, a first insert receivable within the grow channel so as to abut a second insert to form an abutting pair of edges, and a spacing component receivable between the pair of inserts, the spacing component and the abutting edge areas forming an opening extending about the spacing component, the source of moisture/nutrients communicable to the opening. In one aspect, the malleable material insert may have a slot with abutting pair of edges. A rod component is receivable between the abutting pair of edges, the rod and the abutting edges forming an opening extending about the rod component, and the source of moisture/nutrients being communicable to the opening.

### CROSS-REFERENCE TO RELATED APPLICATIONS

This application claims the benefit of U.S. Provisional Application No. 63/247,615, entitled “VERTICAL FARMING WATERING SYSTEM AND METHODS OF MAKING AND USE THEREFOR” filed Sep. 23, 2021, and hereby incorporates by reference herein the entire contents of this priority application.

### FIELD OF TECHNOLOGY

Aspects of the present disclosure relate to the field of farming systems. Specifically, aspects of the present disclosure are directed to a vertical farm and irrigation system for improving and/or enhancing various features of an agricultural growing system.

### BACKGROUND

The need for fresh food is growing as the population increases and fluctuates in the climate impacted growing seasons. The current food supply model, based on traditional farming methods and long distance shipping, is economically and environmentally unsustainable. Traditional farming operations are usually located in agricultural areas, which require large upfront costs, large acreage and high operational costs from seed to sale.

Therefore, there is a need for efficient farming systems and methods and improvements thereto.

Urban agriculture faces obstacles in providing space for growing plants. Space for farming is limited in cities and rarely sufficient to meet a high demand. High start-up and operating costs of greenhouses make local crop production difficult for many businesses. Structures intended to support rooftop greenhouses, for example, must be evaluated by structural engineers and often require additional bracing to support the weight. Urban gardens often must address contaminated soil. Hydroponic systems are not easily used in urban locales, as most hydroponic systems are meant to be installed in agricultural settings, are not easily transportable, and require extensive training of personnel for operation. Thus, self-contained agricultural systems have recently been developed for generating high-yield crops. Such self-contained systems may be located in unused buildings, such as warehouses, or in specialized or repurposed closed or semi-closed environments and often utilize vertically oriented plant arrangements.

In one example approach, such systems may be contained, such as within a modular container or other closed housing (whether fixed or mobile), and may include a growing system that includes various features to support agricultural production, such as a germination station for nurturing seeds until they germinate into plants, a plurality of vertical racks to hold the growing plants, a lighting system to provide appropriate light for the plants, an irrigation system to provide nutrients to the plants, a climate control system to control the environmental conditions within the container, a ventilation system for providing airflow to the plants, and a monitoring system to monitor and control the components of the growing system. Examples of various such features are shown and described with respect to U.S. Pat. No. 10,271,486 titled Insulated Shipping Containers Modified for High-Yield Plant Production Capable in Any Environment, issued Apr. 30, 2019 (also attached hereto as Attachment 1); U.S. Pat. No. 11,026,380 titled Vertical Assembly for Growing Plants, Jun. 8, 2021; U.S. Pat. No. 10,785,925 titled Insulated Shipping Containers Modified for High-Yield Fungi Production Capable in Any Environment, issued Sep. 29, 2020; U.S. Patent Publication No. 2019/0133026 titled Modular Farm Control and Monitoring System, published May 9, 2019; U.S. Patent Publication No. 2020/0037524 titled Modular Farm with Carousel System, published Feb. 6, 2020; and U.S. Patent Publication No. 2020/0359569 titled Hub and Spoke Modular Farm System, published Nov. 19, 2020, each of the foregoing of which is hereby incorporated herein by reference in its entirety.

Various areas that need improvement or enhancement include those relating to aspects of watering and/or nutrition-related features supporting growing crops, including, for example, components making up a system that retains plants in a manner that enables the plants to be readily and easily positioned for growing, such as in a vertical arrangement, watered easily and efficiently during retention in the growing orientation, readily and easily removed from the growing orientation, including for harvesting, but also with regard to temporary removal for other purposes, such as to clear or service various parts of the watering and nutrition components of the system. Such watering and nutrition components may include, for example, various features that deliver moisture and nutrition to individual plants and may need to be regularly serviced.

Problems with existing approaches to vertically-oriented plant growth include roots or other portions of plants growing into or otherwise becoming entwined with wicking elements and/or other components of the system for retaining the plants. For example, roots may grow into the porous aspects of the wicking system and become difficult to remove or extract, and/or the retaining system may include various fabric or other porous materials into which plant roots or other plant features may become entwined. Further, as the roots of the plants grow into the felt wicking and/or other material, the material typically degrades and becomes contaminated by algae or other biological contaminants that utilize nutrients and compete with the crop itself. See, for example, the image of a wicking element with entwined roots and other materials shown FIG. 4. Significant effort may be required to harvest the plants and/or to clean the wicking or other features of the system. In addition, it may become necessary or more efficient to replace such systems regularly, resulting in further inefficiencies and/or increased costs, among other problems. Further, with degradation and algae growth, plants using the wicking approach may receive less nutrients and water, and unequal distribution of nutrients and water may occur. As the degradation increases, the plants closer to the bottom of the wicking strip may become smaller or larger than the ones close to the top of the wicking strip—thereby affecting yield. Servicing may include removing each wicking strip, cleaning out all the roots, washing the felt material in an industrial washing machine, replacing the felt material, and reinstalling. This process is labor intensive and costly. Therefore, there is a need for more efficient features than exist in the related art.

### SUMMARY

Aspects of the disclosure relate to a vertical farm system. In one example aspect, the vertical farm system comprises, at least one rack having a grow channel, a source of moisture or nutrients, wherein the moisture or nutrients are communicably deliverable to the at least one rack, first and second malleable material inserts receivable in the grow channel, each of the malleable material inserts having an edge area and the first insert being receivable within the grow channel so as to abut the second insert to form an abutting pair of edges therebetween, and a spacing component receivable between the abutting pair of inserts, wherein the spacing component and the abutting edge areas cooperatively form at least one opening extending about the spacing component, the source of moisture or nutrients being communicable to the at least one opening.

In one example aspect, the vertical farm system comprises, at least one rack having a grow channel, a source of moisture or nutrients, wherein the moisture or nutrients are communicably deliverable to the at least one rack, at least one malleable material insert receivable in the grow channel, the malleable material insert having a slot, the insert being receivable within the grow channel so as to have first and second edges of the slot forming an abutting pair of edges therebetween, and a rod component receivable between the abutting pair of edges of the insert, wherein the rod component and the abutting edges ooperatively form at least one opening extending about the rod component, the source of moisture or nutrients being communicable to the at least one opening.

In one example aspect, the vertical farm system further comprises a source of light or access to a source of light.

In one example aspect, the vertical farm system further comprises a source of airflow.

In one example aspect, the vertical farm system further comprises a wrap at least partially encapsulating the malleable material inserts.

In one example aspect, the wrap is water impermeable.

In one example aspect, the vertical farm system further comprises at least one plug or plant, when the vertical farm system includes the first and second malleable material inserts, the at least one plug or plant being receivable between the abutting pair of inserts, and when the vertical farm system includes a malleable material insert with a slot, the at least one plug or plant being receivable between the abuttable pair of edges of the slot.

In one example aspect, the received plug or plant communicates with at least one opening.

In one example aspect, the spacing component comprises a rod.

In one example aspect, the rod comprises plastic.

In one example aspect, the rod comprises one or more notches for creating the at least one opening.

In one example aspect, the vertical farm system further comprises a funnel attached to the rod for guiding the moisture and nutrients towards the at least one opening extending about the spacing component.

In one example aspect, the funnel comprises one or more notches for creating the at least one opening.

In one example aspect, the at least one opening forms at least a portion of a channel.

According to one example aspect of the disclosure, an irrigation system usable with a vertical planting system is provided, the vertical planting system including at least one rack having a grow channel, a source of moisture or nutrients, and a source of light or access to a source of light, the irrigation system comprising: a plurality of malleable material inserts, each of the malleable material inserts having at least one edge area, the plurality of malleable material inserts each being receivable within the grow channel, wherein a first one of the plurality of inserts abuts at a first one of the least one edge area with a first one of the at least one edge area of an adjacent second one of the plurality of inserts, and a spacing component receivable between the first one of the plurality of inserts and the second one of the plurality of inserts between the abutting edge areas, wherein the spacing component and the abutting edge areas form at least one opening extending about the spacing component, wherein the source of moisture or nutrients is communicable via the at least one opening with at least a portion of a plant received within the vertical planting system.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates an example container of a modular farm system for plant production in accordance with one example modular farm implementation that includes a vertically oriented irrigation system for providing nutrients and moisture to plants, usable in accordance with various features of the present disclosure.

FIG. 2 illustrates an example implementation of an irrigation system usable with a vertically oriented farm system, such as the example container system of FIG. 1.

FIG. 3A and FIG. 3B illustrate side cross-sectional and overhead cross-sectional views, respectively, of various features of an example vertically oriented farm implementation for providing moisture and nutrients via a solid rod or other spacing component inserted between two pieces of foam or other malleable material in accordance with aspects of the present disclosure;

FIG. 3C illustrates an overhead cross-sectional view that includes a plug and various features relating thereto, in accordance with aspects of the present disclosure.

FIG. 4 shows an image of various aspects of an example vertically oriented farm system for implementing plant growth and delivery of moisture and nutrients, usable in accordance with aspects of the present disclosure.

FIG. 5 contains an image of an example wicking component usable with a vertically oriented system of the related art, following removal from the system, such as during cleaning or during harvesting of plants, producing difficulties addressed by aspects of the present disclosure.

FIGS. 6-8 contain images of plants being removed from a vertically oriented system in accordance with aspects of the present disclosure, such as during cleaning of various portions of the system and/or during harvesting.

FIG. 9 illustrates a side cross-sectional view of various features of an example vertically oriented farm implementation for providing moisture and nutrients using a funnel at the top of a spacing component, such as a rod, in accordance with aspects of the present disclosure.

FIG. 10 contains a top view of various aspects of an example vertically oriented farm implementation using a funnel, in accordance with aspects of the present disclosure.

FIGS. 11-13 contain various additional example views and features including the vertically oriented farm implementation using the funnel of FIG. 10, in accordance with aspects of the present disclosure.

FIG. 14 shows an alternative variation of a funnel and spacing component, such as a rod, in which channels for communicating flow of water and/or nutrients may be formed in the spacing component, and wherein the funnel opening fits about the spacing component such that flow may be communicated to the channels in the spacing component.

FIG. 15 shows a schematic view of the illustrative irrigation system according to an aspect of the present disclosure.

FIGS. 16A and 16B illustrate side cross-sectional and overhead cross-sectional views, respectively, of various features of an example vertically oriented farm implementation for providing moisture and nutrients via a rod component pushed in a slot of a foam or other malleable material in accordance with aspects of the present disclosure.

### DETAILED DESCRIPTION

Aspects of the present disclosure include various features of an irrigation system that address and overcome the shortcomings described above, as well as others. An example irrigation system in accordance with aspects of the present disclosure includes use of abuttingly placed pairs of foam or other malleable material, optionally encased in plastic or other material wrap that prevents root or other plant growth into the malleable material. A plurality of vertically inserted spacing components, such as plastic rods, may be emplaced between the abutting pairs of encased malleable materials, wherein each vertically inserted spacing component may cause a channel or channels, and/or other openings proximal to each inserted spacing component to be formed between the encased malleable materials into and/or through which moisture and/or nutrients may flow.

In other aspects of the present disclosure, the malleable material is not encased. For example, there may be a need to reduce production cost. One way to reduce the production cost is to omit the encasing of the malleable material. Thus, in some aspects, the extent to which protection is provided to roots growing into the malleable material may be weighed against the cost associated with encasing the malleable material. The teachings of the present disclosure may be implemented with or without the encasing of the malleable material, based on user preference.

Additional advantages and novel features of these aspects will be set forth in part in the description that follows, and in part will become more apparent to those skilled in the art upon examination of the following upon learning by practice of the disclosure.

Aspects of the present disclosure relate to improvements and/or enhancements to various features of an agricultural growing system, including, but not limited to watering and/or nutrition-related features supporting growing crops, such as various components making up a system that retains plants in a manner that enables the plants to be readily and easily positioned for growing, such as in a vertical arrangement, watered easily and efficiently during retention in the growing orientation, readily and easily removed from the growing orientation, including for harvesting, but also with regard to temporary removal for other purposes, such as to clear or service various parts of the watering and nutrition components of the system, as well as other benefits.

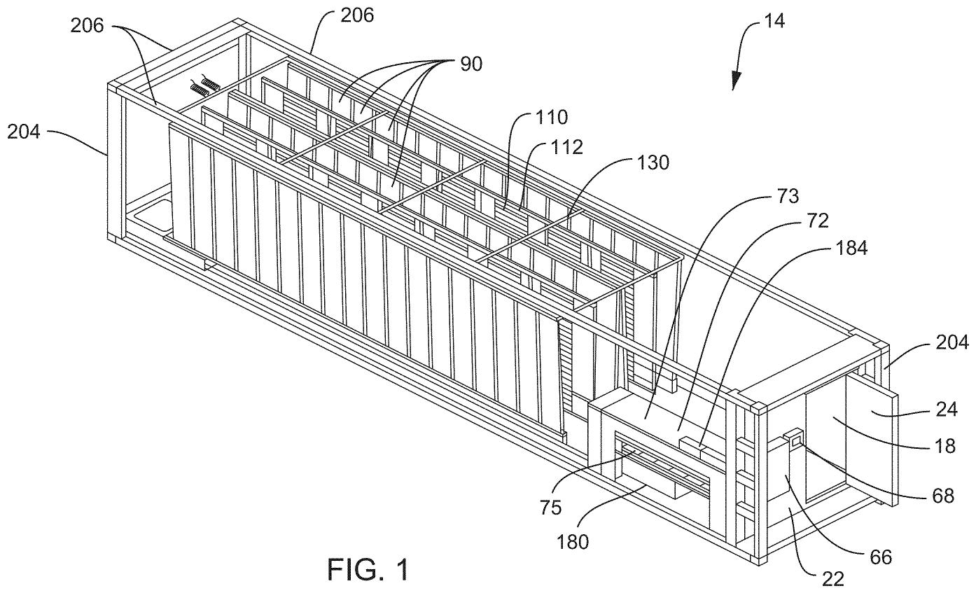

FIG. 1 illustrates one example container of an example modular (fixed or mobile) farm system 14 for plant production, with regard to which various features of the present disclosure may be used. The modular container may include an irrigation system for providing nutrients to the plants. Details of various features that may be included in such a container based modular farm system are shown and described in U.S. Pat. No. 10,271,486 titled Insulated Shipping Containers Modified for High-Yield Plant Production Capable in Any Environment, issued Apr. 30, 2019, a copy of which is attached hereto as Attachment 1.

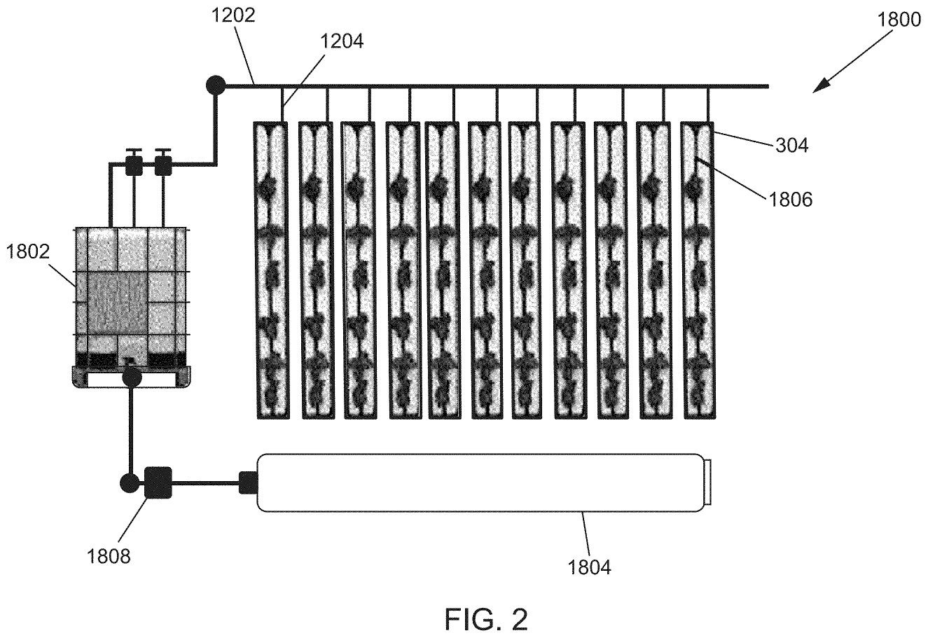

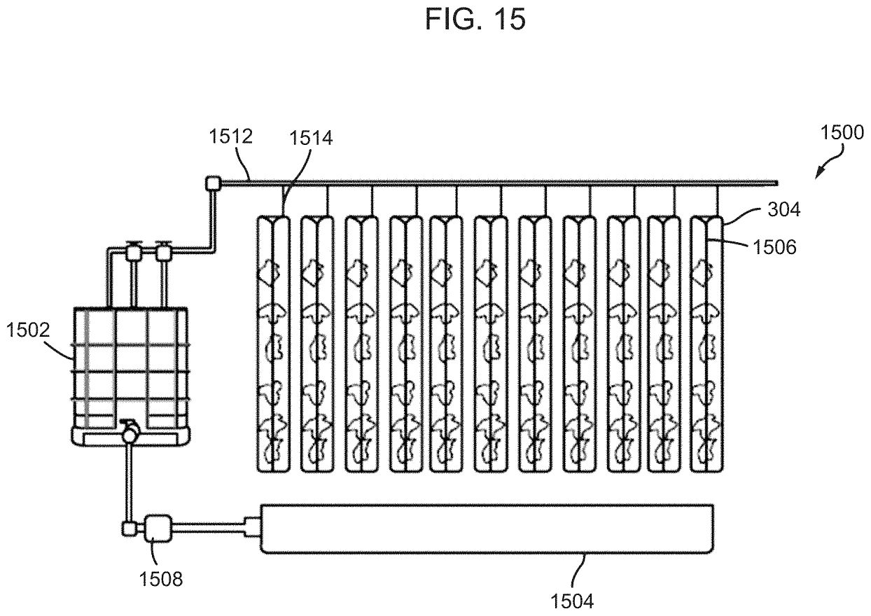

FIG. 2 illustrates various irrigation and watering-related features, such as may be incorporated in the example self-contained system of FIG. 1 (it is noted that these irrigation and watering-related features are not limited to a self-contained system and are discussed only for illustration and with regard to various example features that may be generally utilized for growing plants in enclosed or other environments, particularly where the plants may be grown in a vertically oriented arrangement along the lines as shown and described with respect to FIG. 15 which shows a schematic view of the illustrative irrigation system according to an aspect of the present disclosure; it is further noted that FIG. 2 of the present disclosure is a reproduced and slightly modified copy of FIG. 15). The details relating to FIG. 15 and its description are illustrative of various example features that may optionally be used with the watering system features of the present disclosure. As shown in FIG. 2, irrigation system 1500 may be used to deliver or otherwise enhance delivery of a water/nutrient solution to plants, for example.

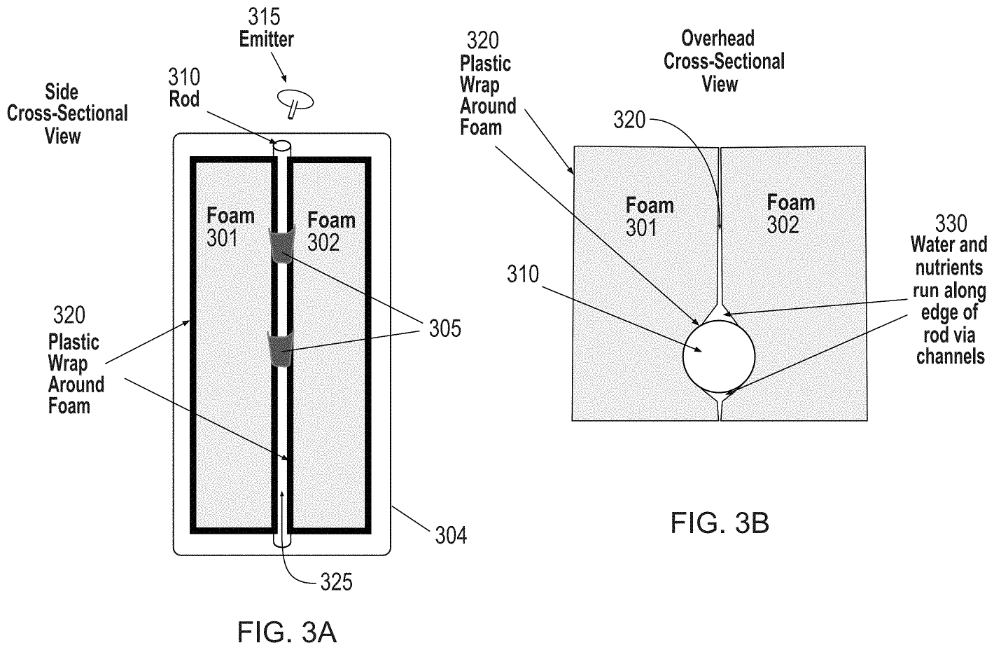

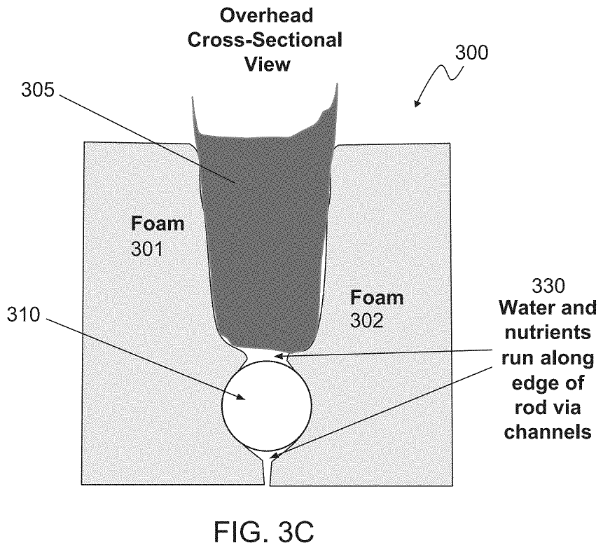

As shown and described with respect to FIG. 15, and as, for example, may be utilized in accordance with aspects of the present disclosure, the irrigation system of FIG. 2 may include a nutrient reservoir 1502, nutrient doser (not shown in FIG. 2), a first set and second set of tubing 1512, 1514 for delivery of water/nutrient solution to grow channels (see FIG. 3A and FIG. 3B) within racks 304. First set of tubing 1512 may communicate the delivery of water/nutrient solution from nutrient reservoir 1502 to each section of the grow channels within racks 304. A second set of tubing 1514 may communicate the delivery of water/nutrient solution from tubing 1512 to each section of grow channels within racks 304. Pump 1508 may be utilized at the point of origin at nutrient reservoir 1502 to regulate the rate of water/nutrient flow through the first set of tubing 1512. Drip emitters (see FIG. 3A) may also be located proximal to the ends of the second set of tubing 1514 to help govern water/nutrient flow at the point of release into each grow channel.

In accordance with aspects of the present disclosure, FIG. 3A and FIG. 3B illustrate side and overhead cross-sectional views, respectively, of various features of a vertically oriented example implementation for providing moisture and nutrients via an inserted solid rod or other spacing component, in accordance with aspects of the present disclosure. As shown in FIG. 3A and FIG. 3B, each rack 304 (e.g., rack 304 of FIG. 2) may include, for example, two pieces of a foam material 301, 302 abuttably placed therein, so as to form an abutting slot or pair of edges 325 therebetween. Each piece of foam or other malleable material 301, 302 may be wrapped by a wrap material 320, such as a plastic material that prevents root and other plant growth into the foam material 301, 302.

A rod or other spacing component 310 may be placed into the slot or pair of edges 325, so as to spaceably form channels or other openings 330 (FIG. 3B) about component 310. The formation of the channels or other openings 330 may occur as a function of the properties of the foam or other malleable material 301, 302 and/or the wrap 320. Moisture and/or nutrients may thus be communicated via such channels or other openings 330.

As shown in FIG. 3A and FIG. 3C, one or more plugs 305 (plugs may comprise moss and a binder about the root of a plant or seedling, or be made of rockwool or other similar substances) may be placed within the abutting slot or pair of edges 325. For example, to make such placement, a portion of the malleable foam 301, 302 and wrap 320 may be pushed open by hand, and each plug 305 inserted into the recessed area, with the plug 305 then communicating with the channels or other openings 330 (see, e.g., FIG. 3C).

In operation, moisture (e.g., water) and/or nutrients may be delivered via emitter 315 (FIG. 3A) to a first end (e.g., an upper end) of the spacing component 310. The moisture and/or nutrients may flow along the spacing component 310 within one or more channels 330 formed by the spacing component 310 being emplaced within the abutting slot or pair of abutting edges 325 between the pair of wrap (320) covered foam or other malleable material inserts 301, 302.

Among other advantages over the related art of using wicking type components and other similar approaches to watering that may enable root or other entwining plant growth, aspects of the present disclosure enable removal of a plurality of plants to be readily performed in a simple process. The approach of using a single spacing component 310 results in the roots of plants growing about and along the length of the spacing component 310 throughout each rack 304. Cleaning of the system and/or harvesting of the plants, for example, may thus simply involve readily extracting the spacing component 310 from the system along with the plants attached by their roots thereto, thereby avoiding, among other things, the difficulties of separating roots/plants from a wicking strip and/or other porous feature-related problems of the related art. Moreover, since the spacing component 310 may comprise somewhat, or completely impermeable material, such as plastic, and the roots may grow about the spacing component 310 while remaining unattached to the wrap or spacing component 310, the plants may be readily harvested by merely being slid along the spacing component 310 until freed at the end. Thus, the irrigation system in accordance with aspects of the present disclosure may further reduce labor during harvesting and/or system cleaning, as well as other problems of the related art.

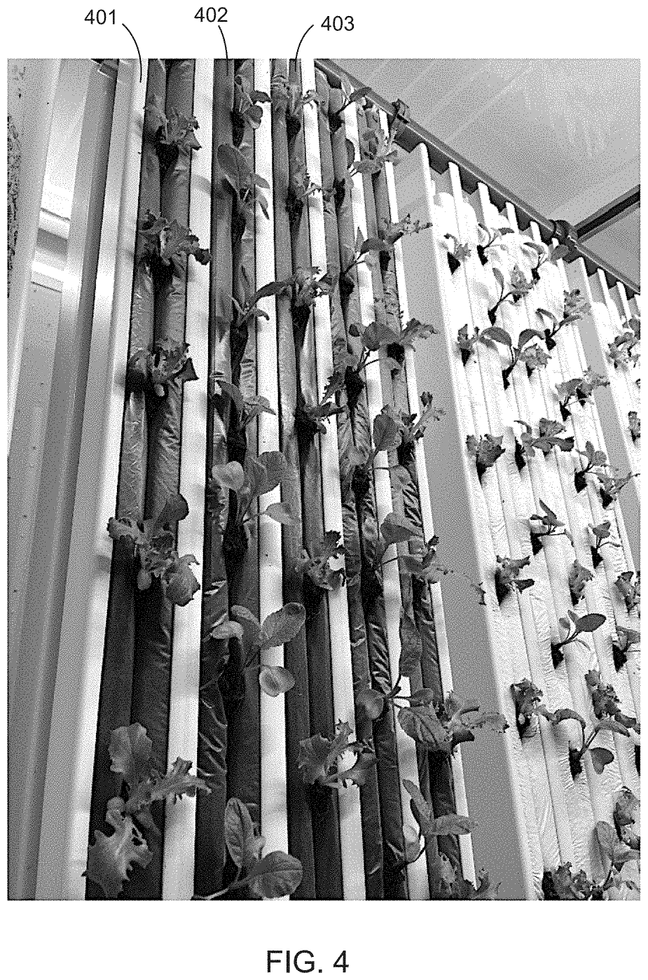

FIG. 4 shows an image of various aspects of an example vertically oriented system for implementing plant growth and delivery of moisture and nutrients, in accordance with aspects of the present disclosure. Vertical racks 401, growth channels 402, and plants 403 are shown.

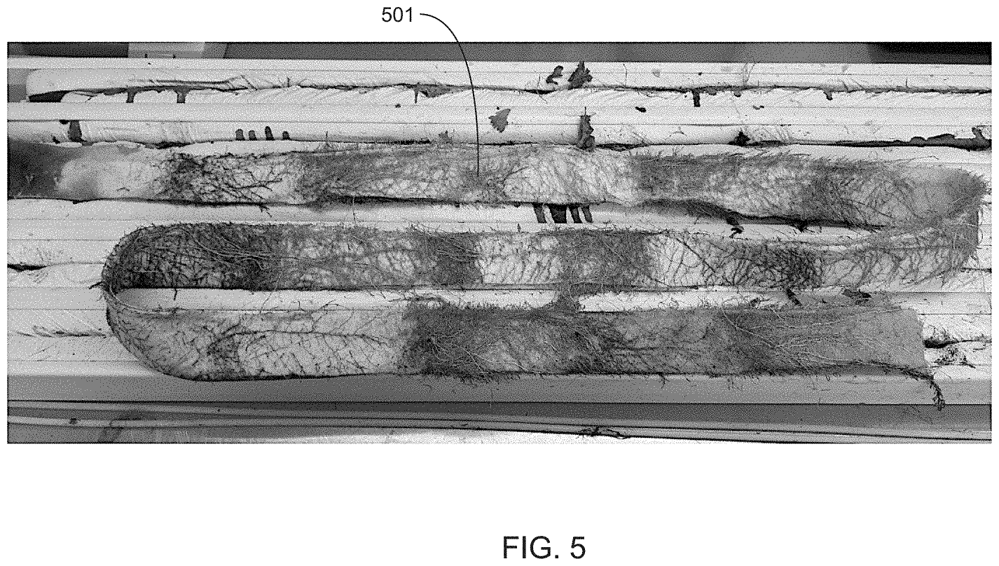

FIG. 5 contains an image of an example wicking component 501 usable with a vertically oriented system, following removal from the system, such as for cleaning or during harvesting of plants, for example, in accordance with aspects of the present disclosure.

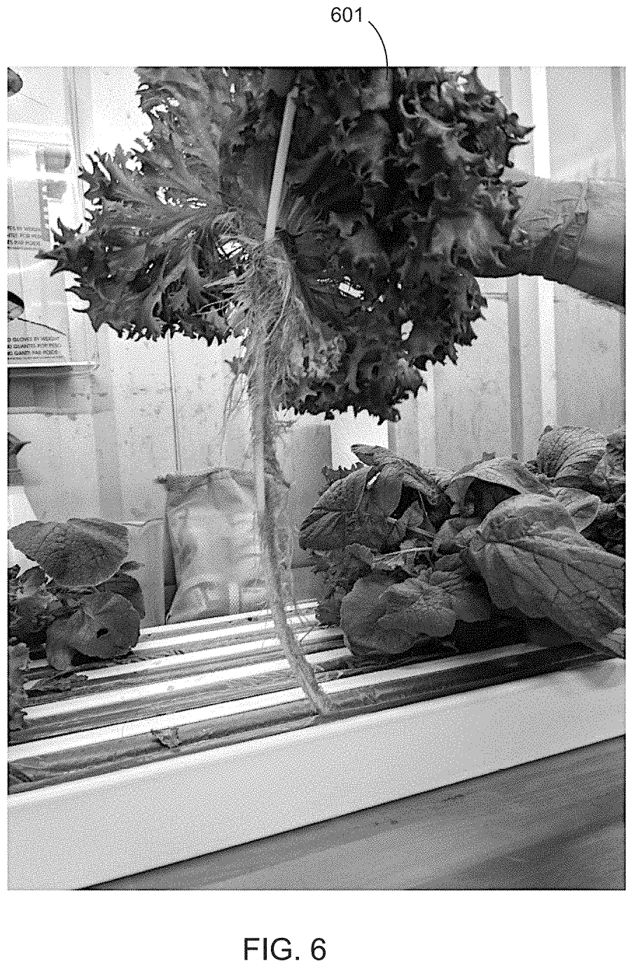

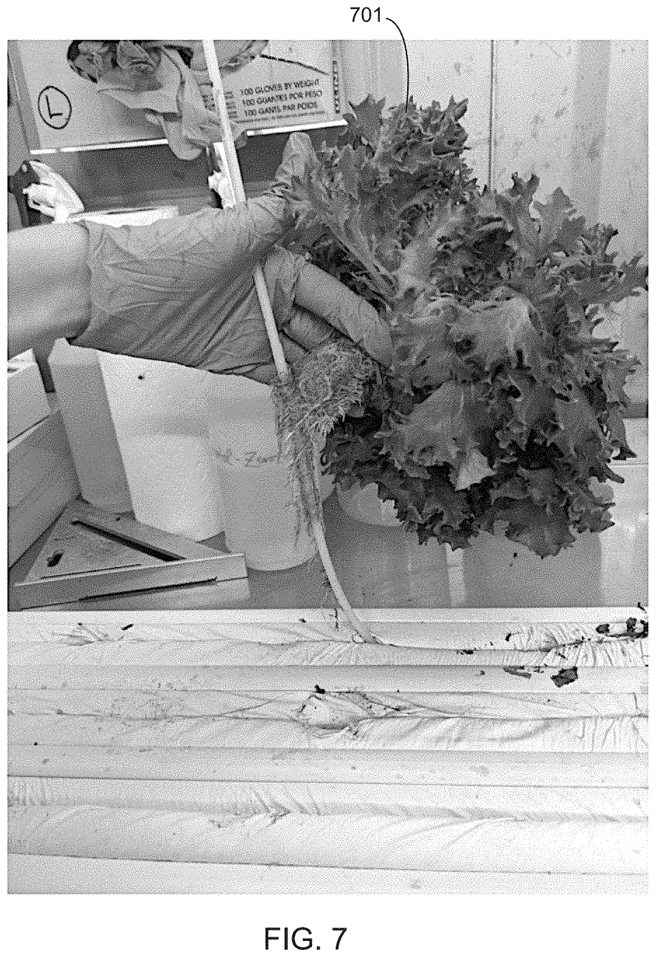

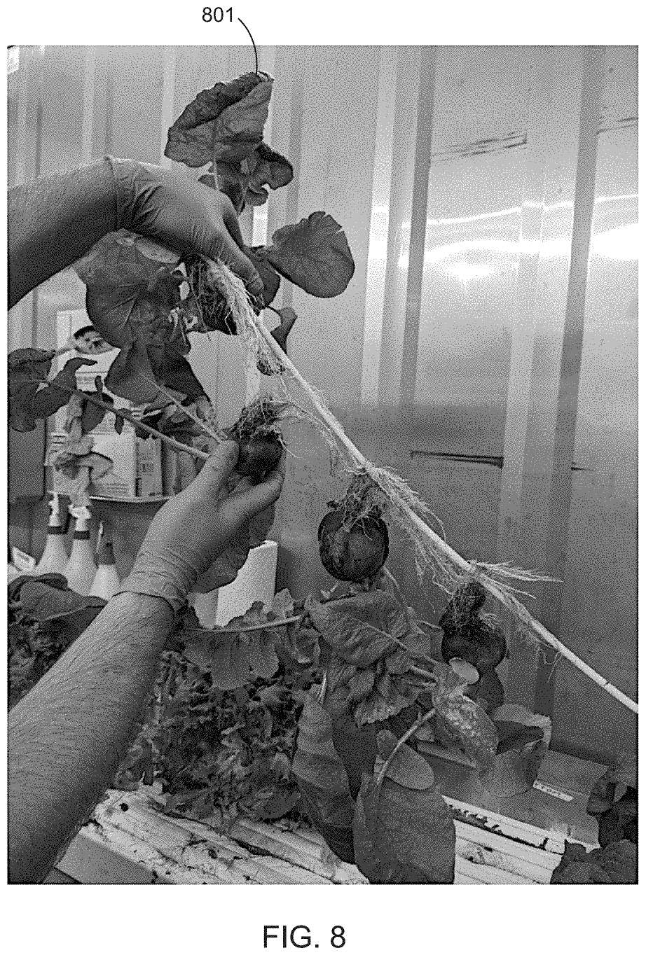

FIGS. 6-8 contain images of respective plants, 601, 701, and 801, being removed from a system in accordance with aspects of the present disclosure, such as during cleaning or harvesting.

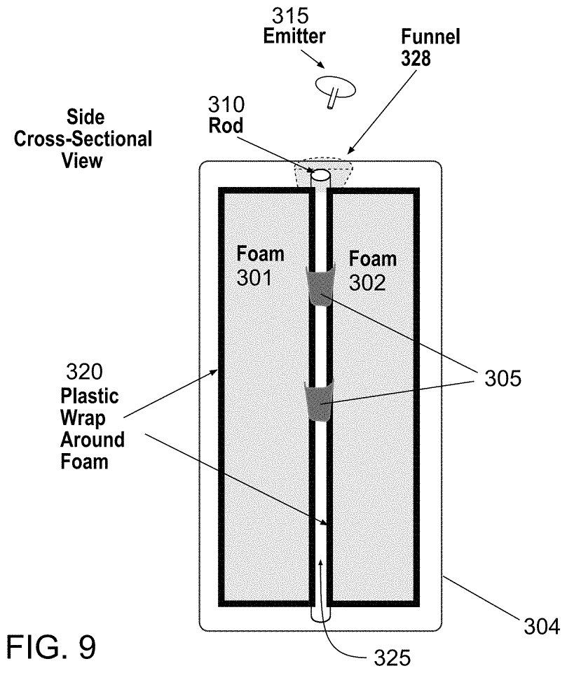

FIG. 9 illustrates a side cross-sectional view of various features of an example vertically oriented farm implementation for providing the moisture and nutrients similar to the implementation of FIGS. 3A-3C, but also including a funnel 328 located at the top of the spacing component 310, as shown in FIG. 9, in accordance with aspects of the present disclosure.

In other aspects, an optional funnel 328 is placed at the first end (e.g., the upper end) of the spacing component 310 to guide the moisture and/or nutrients towards the one or more channels 330 formed by the spacing component 310 being emplaced within the abutting edge 325 between the pair of wrap (320) covered foam or other malleable material inserts 301, 302.

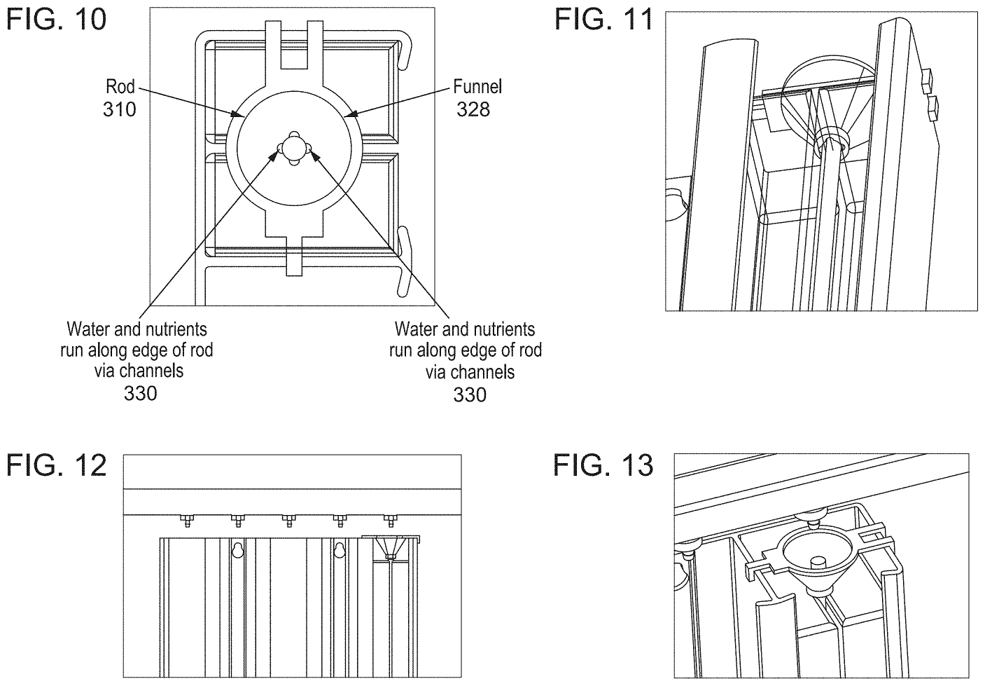

FIG. 10 shows an overhead view of various features of the vertically oriented farm implementation along the lines of the implementation using the funnel 328 of FIG. 9. As shown in FIG. 10, water and nutrients may be communicated to spacing component 310, such as into channels 330 (FIGS. 3B, 3C) located proximal to the spacing component 310, via funnel channels 350 in funnel 328 that may approximately align with channels 330 (FIGS. 3B, 3C). FIGS. 11-13 contain views showing various features of the vertically oriented farm implementation using the funnel 328 of FIGS. 9-10.

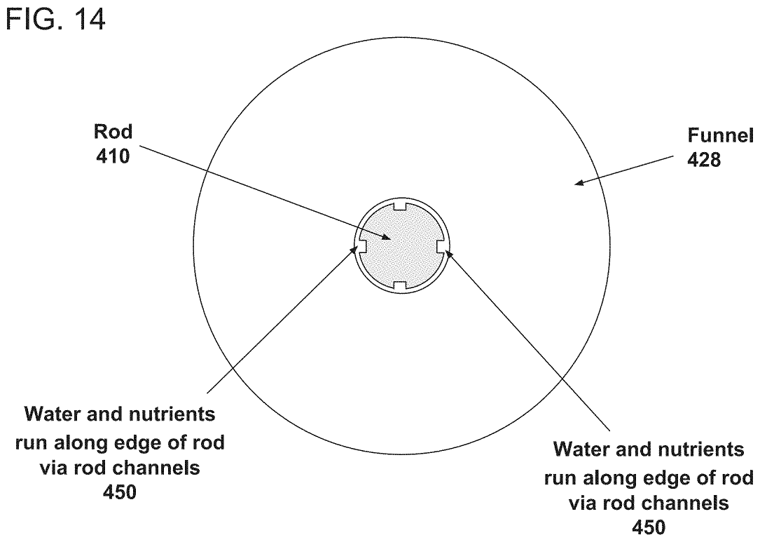

Alternatively to the implementation shown in FIGS. 3A-3C and FIGS. 10-13, in another example implementation shown in FIG. 14, rather than channels 350 being formed in the funnel 328 so as to alignably communicate with channels 330 (FIGS. 3B, 3C), the funnel 428 may be formed without funnel channels, and instead channels 450 may be formed in an alternative implementation of the spacing component 410. For example, such channels 450 may include grooves or other formations inwardly extending from the outer edge of the spacing component 410.

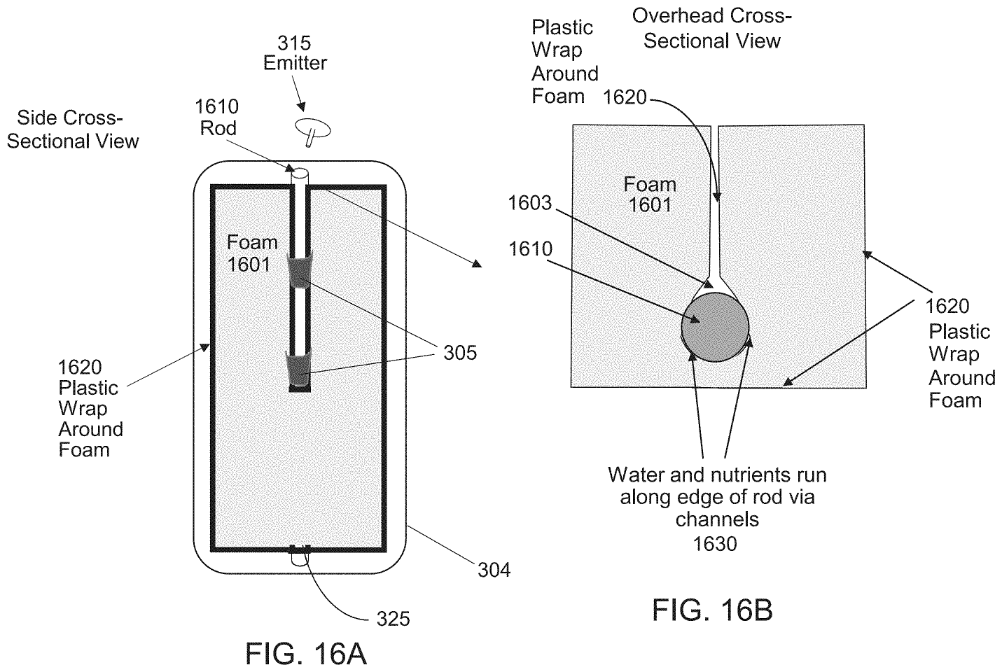

Alternative to the implementation shown in FIGS. 3A-3C and FIGS. 9-10, in another example implementation shown in FIG. 16A, rather than using two pieces of foam material 301, 302 being abuttably placed in each rack 304, each rack 304 may include a single slotted malleable piece 1601. Using the single slotted malleable piece 1601 may simplify the installation of the malleable piece 1601 into a rack 304. The malleable piece 1601 may be wrapped by a wrap material 1620, such as a plastic material that prevents root and other plant growth into the foam material 1601. Using the malleable piece 1601 enables the rod component 1610 to be pushed into the single slot 1603. When the rod component 1610 is placed into the slot 1603, channels or other openings 1630 are formed (FIG. 16B) about the rod component 1610. The formation of the channels or other openings 1630 may occur as a function of the properties of the foam or other malleable material 1601 and/or the wrap 1620. Moisture and/or nutrients may thus be communicated via such channels or other openings 1630.

In operation, moisture (e.g., water) and/or nutrients may be delivered via emitter 315 (FIG. 3A) to a first end (e.g., an upper end) of the rod component 1610. The moisture and/or nutrients may flow along the rod component 1610 within one or more channels 1630 formed by the rod component 1610 being pushed in the slot 1603. In other aspects, an optional funnel, such as the funnel 328 of FIG. 9, may be placed at a first end (e.g., the upper end) of the rod component 1610 to guide the moisture and/or nutrients towards the one or more channels 1630 formed by the rod component 1610 having being pushed into the slot 1603.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

1. A vertical farm system, comprising:
at least one rack having a grow channel;
a source of moisture or nutrients, wherein the moisture or nutrients are communicably deliverable to the at least one rack;
first and second malleable material inserts receivable in the grow channel, each of the malleable material inserts having an edge area and the first insert being receivable within the grow channel so as to abut the second insert to form an abutting pair of edges therebetween; and
a spacing component receivable between the abutting pair of inserts, wherein the spacing component and the abutting edge areas cooperatively form at least one opening extending about the spacing component, the source of moisture or nutrients being communicable to the at least one opening.

2. The vertical farm system of claim 1, further comprising a source of light or access to a source of light.

3. The vertical farm system of claim 1, further comprising a source of airflow.

4. The vertical farm system of claim 1, further comprising a material wrap at least partially encapsulating each of the first and second malleable material inserts.

5. The vertical farm system of claim 4, wherein the wrap is water impermeable.

6. The vertical farm system of claim 1, further comprising at least one plug or plant receivable between the abutting pair of inserts.

7. The vertical farm system of claim 6, wherein the received plug or plant communicates with at least one opening.

8. The vertical farm system of claim 1, wherein the spacing component comprises a rod.

9. The vertical farm system of claim 8, wherein the rod comprises plastic.

10. The vertical farm system of claim 8, wherein the rod comprises one or more notches for creating the at least one opening.

11. The vertical farm system of claim 8, further comprising a funnel attached to the rod for guiding the moisture and nutrients towards the at least one opening extending about the spacing component.

12. The vertical farm system of claim 11, wherein the funnel comprises one or more notches for creating the at least one opening.

13. The vertical farm system of claim 1, wherein the at least one opening forms at least a portion of a channel.

14. An irrigation system usable with a vertical planting system, the vertical planting system including at least one rack having a grow channel, a source of moisture or nutrients, and a source of light or access to a source of light, the irrigation system comprising:
a plurality of malleable material inserts, each of the malleable material inserts having at least one edge area, the plurality of malleable material inserts each being receivable within the grow channel, wherein a first one of the plurality of inserts abuts at a first one of the least one edge area with a first one of the at least one edge area of an adjacent second one of the plurality of inserts; and
a spacing component receivable between the first one of the plurality of inserts and the second one of the plurality of inserts between the abutting edge areas, wherein the spacing component and the abutting edge areas form at least one opening extending about the spacing component;
wherein the source of moisture or nutrients is communicable via the at least one opening with at least a portion of a plant received within the vertical planting system.

15. The irrigation system of claim 14, wherein the vertical planting system further comprises a source of light or access to a source of light.

16. The irrigation system of claim 14, wherein the vertical planting system further comprises a source of airflow.

17. The irrigation system of claim 14, wherein the vertical planting system further comprises a material wrap at least partially encapsulating each of the first and second ones of the plurality of inserts.

18. The irrigation system of claim 17, wherein the material wrap is water impermeable.

19. The irrigation system of claim 14, wherein the vertical planting system further comprises at least one plug or plant receivable between the abutting pair of inserts.

20. The irrigation system of claim 19, wherein the received plug or plant communicates with at least one opening.

21. A vertical farm system, comprising:
at least one rack having a grow channel;
a source of moisture or nutrients, wherein the moisture or nutrients are communicably deliverable to the at least one rack;
at least one malleable material insert receivable in the grow channel, the malleable material insert having a slot, the insert being receivable within the grow channel so as to have first and second edges of the slot forming an abutting pair of edges therebetween; and
a rod component receivable between the abutting pair of edges of the insert, wherein the rod component and the abutting edges operatively form at least one opening extending about the rod component, the source of moisture or nutrients being communicable to the at least one opening.

22. The vertical farm system of claim 21, further comprising a source of light or access to a source of light.

23. The vertical farm system of claim 21, further comprising a source of airflow.

24. The vertical farm system of claim 21, further comprising a material wrap at least partially encapsulating the malleable material insert.

25. The vertical farm system of claim 24, wherein the wrap is water impermeable.

26. The vertical farm system of claim 21, further comprising at least one plug or plant receivable between the abutting pair of edges of the insert.

27. The vertical farm system of claim 26, wherein the received plug or plant communicates with at least one opening.

28. The vertical farm system of claim 21, wherein the rod comprises plastic.

29. The vertical farm system of claim 21, wherein the rod comprises one or more notches for creating the at least one opening.

30. The vertical farm system of claim 21, further comprising a funnel attached to the rod for guiding the moisture and nutrients towards the at least one opening extending about the rod component.

31. The vertical farm system of claim 30, wherein the funnel comprises one or more notches for creating the at least one opening.

32. The vertical farm system of claim 21, wherein the at least one opening forms at least a portion of a channel.
